(19) United States
(12) Patent Application Publication
(10) Pub. No.: US 2011/0127155 A1
(43) Pub. Date: Jun. 2, 2011

(54) PROCESS FOR THE TREATMENT OF THE AQUEOUS STREAM COMING FROM THE FISCHER-TROPSCH REACTION

(75) Inventors: Lino Carnelli, Carbonate (Como) (IT); Roberta Miglio, Oleggio (Novara) (IT); Paolo D'Olimpio, Novara (IT)

(73) Assignee: ENI S.P.A., Roma (IT)

(21) Appl. No.: 12/863,101

(22) PCT Filed: Jan. 14, 2009
(86) PCT No.: PCT/EP2009/000390

§ 371 Date: Jan. 18, 2011

(30) Foreign Application Priority Data
Jan. 18, 2008 (IT) MI2008A000078

(51) Int. Cl. C02F 9/08

(52) U.S. Cl. 203/10

(57) ABSTRACT

The present invention relates to a process for the treatment of the aqueous stream coming from the Fischer-Tropsch reaction, comprising: —feeding the aqueous stream (1) containing organic by-products of the reaction to a distillation or stripping column (10); —collection from the column of a distillate (2) enriched in alcohols having from 1 to 8 carbon atoms and other possible volatile compounds—feeding the aqueous stream leaving the bottom of the column (3) to a reverse osmosis unit (20) and the production of two outgoing streams; —an aqueous stream (4) enriched in organic acids with from 1 to 8 carbon atoms; —a partially purified aqueous stream (5) with a low acid content.

The present invention relates to a process for the treatment of an aqueous stream coming from the Fischer-Tropsch reaction.

More specifically, the invention relates to a process for the treatment of the aqueous stream coming from the Fischer-Tropsch reaction by the combination of a distillation/stripping step and a reverse osmosis step, which allows a concentrated stream of C₁-C₈ organic acids, a concentrated stream of C₁-C₈ alcohols with a reduced water content and a stream of water purified to the desired quality, to be obtained.

The Fischer-Tropsch technology for preparing hydrocarbons from mixtures of gases based on hydrogen and carbon monoxide, conventionally known as synthesis gas, is known in scientific literature. A summary of the main works on the Fischer-Tropsch synthesis is contained in the Bureau of Mines Bulletin, 544 (1955) entitled “Bibliography of the Fischer-Tropsch Synthesis and Related Processes” H. C. Anderson, J. L. Wiley e A. Newell.

The process for the production of hydrocarbons with the Fischer-Tropsch reaction generates an amount, by weight, of water which is greater than the total amount produced of hydrocarbons, following the production of a mole of water for each mole of CO converted into hydrocarbons.

Before purification, the reaction water (co-produced water), is subjected to preliminary separations; typically it passes through a three-phase separator from which an organic condensate is obtained, together with a vapour phase and the aqueous phase which still contains organic compounds dissolved and in suspension and which is preferably treated in a coalescence filter.

Other water of the same process, rain water or other service water present in the production site, can be added to the water co-produced. The water thus obtained is contaminated by hydrocarbon compounds, typically less than 1,000 ppm, and by oxygenated compounds, soluble in water. The amount of contaminants depends on the catalyst and on the reaction conditions, in particular temperature and pressure. The amount of oxygenated compounds on the whole increases with an increase in the reaction temperature, more significantly the group of acids.

The main oxygenated contaminants are light alcohols such as methanol and ethanol, indicatively present in an amount of from 0.5 to 5% by weight. Heavier alcohols are also present in a lower amount (for example, propanol, butanol, pentanol) and other oxygenated compounds, such as aldehydes (e.g. acetaldehyde, propionaldehyde, butyraldehyde), ketones (acetone, methylpropyl ketone) and acids (e.g. formic, acetic, propionic, butyric, isobutyric, valeric, hexanoic, heptanoic, octanoic acid), the latter indicatively at concentrations lower than 1.5%. The amount of compounds present, within each group, decreases with an increase in the molecular weight, and compounds with up to 25 carbon atoms are included. The water can also contain small amounts of nitrogenated and sulfurated compounds deriving from the feedstock used, in addition to traces of metal coming from the reactor. The metals can also be present in the form of suspended solids.

The stream as such does not have a commercial value and cannot be disposed of as such, the oxygenated compounds (acids), moreover, give corrosive properties, the hydrocarbons have the tendency to form foams (foaming).

A water treatment system is therefore necessary for allowing the water within the FT process to be re-used, for example as cooling water in the synthesis section, or for its disposal outside or for other additional uses, such as irrigation water or drinking water.

The treatment or combination of treatments on the co-produced water is determined by the restrictions imposed by the final use of the water and organic compounds present therein.

The water treatment system is normally of the biological type which can be preceded by a treatment, typically of stripping/distillation to remove the most volatile compounds. The water deriving from the biological treatment is then normally subjected to a further finishing treatment to remove the solids and, if necessary, also the residual salts from the biological treatment. An approach of this type is suggested for example in U.S. Pat. No. 7,166,219, U.S. Pat. No. 7,150,831, U.S. Pat. No. 7,153,392 (SASOL) and WO 2005113426 (STATOIL—PETROLEUM OIL & GAS CORP SOUTH AFRICA).

In some of the operating phases of the Fischer-Tropsch plant, there is a significant presence in the co-produced water of metals and suspended solids deriving from the catalyst, and this must be specifically controlled in relation to the final destination of the water, as proposed, for example, in US 2005-667991P (STATOIL).

When the water is treated by means of a biological process, the organic compounds contained therein are degraded to CO₂ and H₂O or CO₂, CH₄ and H₂O and the dosage of the chemicals required by the biological process, whether it be of the aerobic or anaerobic type, leads to the production of a sludge, which indicatively ranges from 0.05-0.5 kg per kg of biodegraded COD.

Biological treatment is generally costly for the chemicals (for example urea, phosphates, . . . ) which must be dosed and for the high volumes of the tanks/treatment reactors, as the biological reaction times are in the order of hours, and for the air to be insufflated when aerobic treatment is used. Another drawback of biological treatment is that the organic compounds present in the water cannot be upgraded.

Should the organic compounds present in the co-produced water be upgraded instead of biodegraded, a physico-chemical treatment must be applied. In U.S. Pat. No. 6,462,097 (IFP-ENI), for example, an adsorption step on activated carbons is envisaged, after the stripping treatment, the regeneration stream of activated carbons, rich in organic compounds can then be re-fed to the synthesis reactor. Similar suggestions are also provided in U.S. Pat. No. 6,225,358 (SYNTROLEUM CORP), U.S. Pat. No. 5,053,581, U.S. Pat. No. 5,004,862 (EXXON), in which the organic compounds, for example C₁-C₆ alcohols, present in the co-produced water are returned to simple molecules, i.e. upgraded to COx/yH₂ (syngas).

Other types of treatment, of the physico-chemical kind, allow one or more streams concentrated in organic compounds to be separated, contemporaneously with the production of water purified to the desired degree.

It is possible to separate by distillation, for example, as described in US 2004 0262199 (SASOL) and in Italian patent application MI07A001209 (ENI), a prevalently alcohol stream with a content of non-acid compounds (NAC) ranging from 55% to a maximum of 85%. This stream can be used as fuel or alternatively it can be further processed to recover the valuable products.

The formation, by physico-chemical treatment, of one or more streams concentrated in various groups of organic compounds, contemporaneously with the production of water purified to the required degree, is described for example in U.S. Pat. No. 7,153,432 B2 (SASOL) which proposes a process with at least two steps, the first a distillation step and the second a separation step with membranes, plus, if necessary, other accessory steps for bringing the purified water to the required degree of purity.

This process, however, suffers from substantial disadvantages deriving from the necessity of having to modify the natural pH of the co-produced water which, depending on the concentration and distribution of the acids present, is indicatively within the range of 2.5-3.5 to bring it to 4-7, at which the commercial membranes (polyamide-polyester) in particular of RO, have rejections >99.6 with the practically stoichiometric consumption of base (for example, NaOH) and the production of a stream concentrated (for example 6% by weight) in salts (for example Na) of the corresponding acids.

A process has now been found, which allows two or more streams concentrated in different groups of organic compounds to be obtained, by means of the original combination of physico-chemical type treatment, contemporaneously with the production of water purified to the required degree, completely eliminating or minimizing the addition of alkalis.

In particular, the process of the invention allows a stream concentrated in alcohols and a stream concentrated in acids (not in their salts), and contemporaneously water purified to the required degree, to be obtained, simply and conveniently. The purified water can be of a suitable quality for being reused in the same process or suitable for use in agriculture or disposable as surface water, according to law legislations.

In accordance with this, an object of the present invention relates to a process for the purification of an aqueous stream coming from the Fischer-Tropsch reaction, comprising:
feeding the aqueous stream containing organic by-products of the reaction to a distillation or stripping column;
collection from the column of a distillate (i) enriched in alcohols having from 1 to 8 carbon atoms and other possible volatile compounds;
feeding the aqueous stream leaving the bottom of the column to a reverse osmosis unit and the production of two outgoing streams;
an aqueous stream (ii) enriched in organic acids with from 1 to 8 carbon atoms;
a partially purified aqueous stream (iii) with a low acid content.

The Fischer-Tropsch synthesis can be effected as described in U.S. Pat. No. 6,348,510.

In relation to the purification degree to be obtained and to the amount of alkalis to be used, the process can also comprise an electrodialysis step. This step allows a stream concentrated in organic acids and a basic stream (for example NaOH, NH₄OH) to be separated from a stream containing organic acids in the form of salts.

The basic stream can be fed to the reverse osmosis unit to modify the pH of the partially purified stream by a first reverse osmosis step and then subjecting it to a second step at pH 4-8. In this pH range, the characteristic rejections of the membranes are higher with respect to the characteristic rejections of the membranes at the natural pH of the stream, normally 2.5-3.5. The concentrate leaving the second reverse osmosis step represents the feeding to the electrodialysis step.

Additional preliminary, intermediate or final steps can also be envisaged, which can envisage filtration, adsorption, ion exchange, precipitation or redox operations.

Distillation can be effected on the stream permeated by the reverse osmosis unit or, preferably, the co-produced water is first subjected to distillation and the bottom stream of the distillation is fed to the reverse osmosis unit.

The pH of the co-produced water or of the bottom stream of the distillation column depends on the acid contamination (these normally being <1.5%), the pH is normally <4. The higher the acid contamination, the lower the pH will be. Among the acids, the acid normally present at higher concentrations in the reaction water is acetic acid, which can indicatively represent about 50% of the overall acidity.

The maximum concentration value of the acids which can be reached in the reverse osmosis unit mainly depends on the osmotic pressure of the solution, which, in a first approximation, has a linear dependence on the concentration of the acids.

For acetic acid at a concentration of 13% by weight, for example, the osmotic pressure of the solution is slightly less than 60 Bar (CRC Handbook osmolality of acetic acid solutions at 20° C.). This leads to the selection of suitable membranes on the basis of the concentration to be reached and therefore the pressures at which they can be used. In order to concentrate acids over 10% it is necessary to use membranes capable of operating at pressures of at least 45 Bar, better if >60 Bar.

At the natural pH of the co-produced water, at pH <4, the rejections of commercial membranes for reverse osmosis, also those defined as high rejection, do not exceed 80% for acetic acid and are lower for formic acid, indicatively they do not exceed 50%. For higher acids, the rejection progressively rises to values of 85 and 90%. The rejection values also depend on the concentration of the acids, they normally tend to increase when the solution is diluted (for example from 10 to 2%) but below a concentration threshold (indicatively 1%) within which the co-produced water of the Fischer-Tropsch synthesis falls, the variations can be considered as being of little significance. The residual concentration of acids in the partially purified water is therefore limited by these rejection values and depends on the concentration of acids initially present. For example, with 100-10,000 ppm of acids in the water and average rejections of 80%, the residual acids will indicatively range from 20 to 2,000 ppm.

A stream (concentrate) concentrated in acids, indicatively from 3 to 12%, will therefore leave the reverse osmosis unit to which the co-produced water stream or the bottom of the distillation column is fed, in relation to the types of membranes and working pressure, in addition to a partially purified stream (permeate) with acids at concentration depending on the initial concentration of the stream, for example ranging from 20 to 2,000 ppm. The concentrated stream will preferably have an acid concentration of 6 to 10% with a higher weight for the acids having a higher molecular weight with respect to the partially purified stream, which, on the contrary, is richer in acids having a lower molecular weight.

The stream partially purified by the reverse osmosis unit can be further purified to reach a quality which is sufficient for it to be reused or disposed of.

As is known to the expert in the field, see for example U.S. Pat. No. 5,028,336 (Texaco nano-filtration membranes with modified pH) it is sufficient to increase the pH of the solution, by salifying the acids present, to obtain with the reverse osmosis membranes, but with this expedient also with other membranes, such as nano-filtration membranes, much more advantageous rejection values, typically higher than 99.6%, allowing an almost complete removal of the acids from the permeate.

The pH of the partially purified stream (permeate coming from the reverse osmosis unit) is then brought within the range of 5-9 by adding a base, for example NaOH or NH₄OH, and is fed to a second reverse osmosis step to produce a fully purified stream (permeate) with a residual acid content indicatively lower than 50 ppm and a stream (concentrate) concentrated in the salts of carboxylic acids, indicatively within the range of 4-8% in the salts (for example of Na) of acids.

The stream concentrated in the salts of carboxylic acids can be treated by means of electrodialysis to produce a stream of acids with an indicative concentration of 3-6.5% in relation to the inlet concentration of the salts and contemporaneously a basic stream, NaOH for example, to be reused for modifying the pH of the water which enters the second step of the reverse osmosis. The conversion of the salified acids into the corresponding acids and bases can have an indicative yield of >95.

In relation to the pH to be adopted with the membranes of the second reverse osmosis step, it may be necessary to add further base in addition to that produced by the electrodialysis step. The position of the addition is not binding.

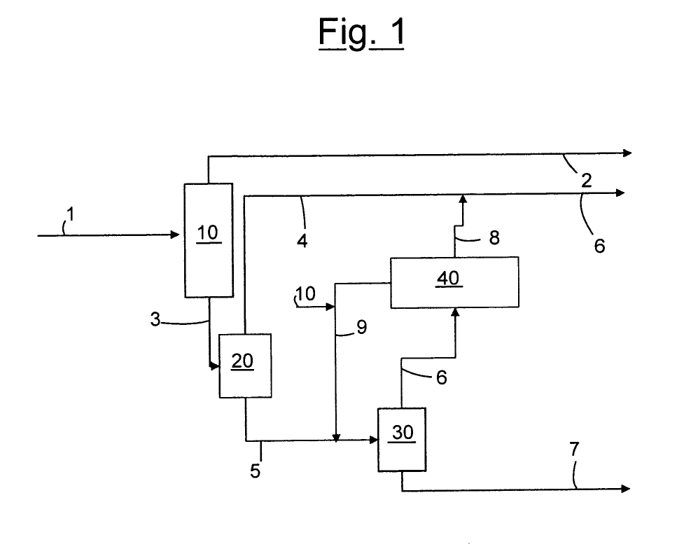

FIG. 1 shows a simplified scheme of the proposed process. The co-produced water (stream 1) is subjected to distillation (10). A stream (stream 2) enriched in volatile products, substantially alcohols, leaves the distillation column, an aqueous stream containing acids (stream 3) leaves the bottom of the distillation column. The acid stream is fed to a reverse osmosis unit (20), from which a partially purified streams (stream 5) and an acid concentrated stream (stream 4) leave.

The partially purified stream (5) is then fed to a second reverse osmosis step (30) after bringing the pH within the range of 5-9. The pH is modified by the addition of a basic stream (stream 9). A stream concentrated in salts of carboxylic acids (stream 6) and a fully purified stream (stream 7) leave the second osmosis step. The concentrated stream leaving the second osmosis step is fed to an electrodialysis step (40) to obtain an acid stream due to the presence of carboxylic acids (stream 8) and a solution of NaOH (stream 9), to be recirculated as basic solution to be fed to the second reverse osmosis step; it may be necessary to add a further base (NaOH, for example), depending on the pH, to the stream leaving the electrodialysis step (stream 10).

Some illustrative and non-limiting examples are provided for a better understanding of the present invention and for its embodiment.

### EXAMPLE 1

The water separated by decanting from the effluent of the FT synthesis, carried out as disclosed by U.S. Pat. No. 6,348,510 (IFP-ENI) is fed to a distillation column. The composition of the bottom of the distillation column is indicated in table 1 column A.

200 g of the solution coming from the bottom of the distillation column are introduced into a static membrane-holder cell, in which a commercial reverse osmosis membrane of the type FILMTEC SW30HR is assembled on a sintered steel septum. The liquid is in contact with the membrane, in the lower part, and is pressurized at 30 bar, by applying a pressure of N₂ above the liquid itself.

Maintaining the cell at room temperature, the liquid permeating from the membrane is collected, weighed and analyzed. The content of acids, determined after collecting 20% of the initial liquid present in the cell, is indicated in table 1, column B. In column B, the rejection value is calculated to the side of the concentration, wherein:

R=(Cf−Cp)/Cf
with Cf=concentration of the acid in the initial liquid (column A)
   Cp=concentration of the acid in the permeated liquid (column B)

TABLE 1

| | A | B | |
|---|---|---|---|
| | mg/l | mg/l | R |
| C1H2O2 | 175.6 | 101.3 | 0.42 |
| C2H4O2 | 747.5 | 185.6 | 0.75 |
| C3H6O2 | 129.4 | 27.5 | 0.79 |
| C4H8O2 | 79.5 | 12.3 | 0.85 |
| C5H10O2 | 41.6 | 5.7 | 0.86 |
| Total acids | 1195.7 | 334.4 | 0.72 |

The rejections obtained on the co-produced water, at its natural pH (<4), without the addition of a base, are those indicated in the table. In the case of the best performances (Sea Water high-rejection membrane), the average rejection proved to be 0.72, i.e. it is possible to remove 72% of the acids present which, if starting from 1195.7 ppm of acids, would mean partially purifying the water at 334.4 ppm of residual acidity.

### EXAMPLE 2

200 g of a solution of the same type as that used in example 1, to which an amount of NaOH has been added which is such as to bring the pH of the solution to a value of 8.5, are introduced into a static membrane-holder cell, in which a commercial reverse osmosis membrane of the type FILMTEC BW30LE is assembled on a sintered steel septum.

The liquid is in contact with the membrane, in the lower part, and is pressurized at 30 Bar, by applying a pressure of N₂ above the liquid itself.

Maintaining the cell at room temperature, the liquid permeating from the membrane is collected, weighed and analyzed. The content of acids, determined after collecting 20% of the initial liquid present in the cell, is indicated in table 2, column B, the rejection value is also calculated to the side of the concentration.

TABLE 2

| | A | B | |
|---|---|---|---|
| | mg/l | mg/l | R |
| C1H2O2 | 175.5 | 1.7 | 0.99 |
| C2H4O2 | 716.5 | 3.8 | 0.99 |
| C3H6O2 | 132.3 | <2 | >0.98 |
| C4H8O2 | 77.6 | <2 | |
| C5H10O2 | 41.1 | <2 | |
| Total acids | 1161.2 | <11.5 | >0.98 |

1. A process for the treatment of the aqueous stream coming from the Fischer-Tropsch reaction, comprising:
feeding the aqueous stream containing organic by-products of the reaction to a distillation or stripping column;
collection from the column of a distillate (i) enriched in alcohols having from 1 to 8 carbon atoms and other possible volatile compounds;
feeding the aqueous stream leaving the bottom of the column to a reverse osmosis unit and the production of two outgoing streams;
an aqueous stream (ii) enriched in organic acids with from 1 to 8 carbon atoms;
a partially purified aqueous stream (iii) with a low acid content.

2. The process according to claim 1, wherein the distillate enriched in alcohols has an overall alcohol concentration within the range of 25-750; the aqueous stream (ii) has an organic acid concentration ranging from 3 to 12%; the aqueous stream (iii) has an acid concentration ranging from 20 to 2,000 ppm.

3. The process according to claim 2, wherein the aqueous stream (ii) has a concentration of organic acids ranging from 6 to 10%.

4. The process according to claim 1, wherein the aqueous stream containing the organic by-products is first fed to the reverse osmosis unit and the aqueous stream (iii) leaving the reverse osmosis is fed to the distillation column.

5. The process according to claim 1, wherein the aqueous stream (iii) leaving the reverse osmosis unit is brought to a pH ranging from 5 to 9 by the addition of a base and is fed to a second reverse osmosis step to produce an outgoing aqueous stream (iv) enriched in the salts of organic acids at a concentration ranging from 4 to 7% and an outgoing aqueous stream of permeate (v) completely purified with an acid content lower than 50 ppm.

6. The process according to claim 5, wherein the stream (iv) enriched in the salts of organic acids is treated by means of electrodialysis to produce a stream of acids (vi) and contemporaneously a basic stream (vii) to be reused for modifying the pH of the aqueous stream (iii).
